(19) United States
(12) Patent Application Publication
(10) Pub. No.: US 2007/0100731 A1
(43) Pub. Date: May 3, 2007

(54) System and method for trading short-term rate derivative futures

(76) Inventors: Declan Ward, London (GB); Amanda Sudworth, London (GB)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/260,491

(22) Filed: Oct. 28, 2005

(51) Int. Cl. G06Q 40/00

(52) U.S. Cl. 705/37

(57) ABSTRACT

A method and system for facilitating trading of a plurality of financial derivative products are provided. Financial derivative products called strips, packs, bundles, and condors are defined, and each is based on combinations of quarterly deliveries of a short term interest rate (STIR) futures contract. The system includes a server at which each product is actively traded, and an interface in communication with the server. The interface enables a user to buy or sell a product. The server accepts bids and offers for strips, packs, bundles, and condors, and also accepts bids and offers for individual quarterly deliveries of the STIR futures contract. The server automatically combines accepted bids and offers into sets of quarterly deliveries, and then automatically matches resulting combinations with bids or offers for strips, packs, bundles, or condors, such that market efficiency and liquidity are increased.

### BACKGROUND OF THE INVENTION

1. Field of the Invention

The present invention relates to the field of financial markets. More particularly, the invention relates to the trading of financial instruments which have multiple quarterly maturity months, stretching out several years, such as the Euribor futures market, the Eurodollar futures market, and the Short Sterling futures market.

2. Related Art

Volatility and uncertainty are ever present in today's financial markets, not least in the interest rate markets. In the face of this type of uncertainty, treasurers and fund managers are increasingly advised to consider methods of managing their exposure to sharp movements in the financial markets. Short Term Interest Rate (STIR) futures and options can provide the flexibility and security required.

Treasurers, fund managers and other market participants have a number of choices available to them to help them manage their interest rate exposure. This may be accomplished either by using exchange-traded products, like futures and options contracts, or over-the-counter (OTC) products, such as swaps, Forward Rate Agreements (FRAs), caps, and floors, together with the underlying cash markets themselves. Indeed, successful players in today's volatile markets typically employ the full range of available risk management and trading strategies.

Exchange-traded futures and options contracts offer market participants not only a high degree of versatility in their use, but also significant advantages as strategic instruments, especially when complemented by OTC derivative and cash market financial instruments. Indeed, when used effectively, exchange-traded futures and options contracts, in conjunction with cash market and OTC derivative instruments, can enhance returns, reduce risks and manage interest rate risks with greater certainty, precision and economy.

A derivative financial product refers to any financial product that derives from another financial product, usually (but not always) the underlying cash markets. STIR futures, as derivative products, derive from the underlying cash money markets.

A futures contract is a legally binding agreement, concerned with the buying, or selling, of a standardized product, at a fixed price, for cash settlement or physical delivery on a given future date. In the case of STIR futures, the standardized product is short-term interest rates. STIR futures contracts derive from the cash inter-bank markets, and are concerned with the trading of the implied value of the three-month LIBOR (£ and CHF), Euribor ( [symbol] ), Eurodollar ($) or TIBOR (Yen). Currently, for example, Euronext.liffe makes the following STIR futures available for trading, as shown below in Table 1:

TABLE 1
STIR Futures Contracts Specifications on Euronext.liffe

| | Euroswiss | Eurodollar | Euribor | Euroyen | Short Sterling |
|---|---|---|---|---|---|
| Unit of Trading | SFr1m | US$1m | [symbol] 1m | Euroyen100m | £500,000 |
| Delivery Months | March, June, September, December (plus serial) | | | | |
| Last Trading Day | Two business days prior to third Wednesday | | | | Third Wed |
| Quotation | 100.00 minus rate of interest | | | | |
| Price Movement | 0.01 | 0.005 | 0.005 | 0.005 | 0.01 |
| (Value) | SFr 25 | $12.50 | [symbol] 12.50 | Y1250 | £12.50 |

A trader enters an order into an electronic STIR futures market by entering a “bid” (i.e., an intention to buy) or an “offer” (i.e., an intention to sell) into the system. When prices for bids and offers are matched, a trade confirmation is generated by the electronic trading platform. Users of the system may enter bids or offers into individual contract months, or directly into the strategy markets, as defined below. At the end of trading, the exchange publishes a settlement price for each individual contract month on each STIR product. Settlement prices are defined by the exchange, and take into account price at which trades are occurring, and the relative weight of bids and offers in the marketplace. A futures contract has a closing, or settlement price, every day at the end of trading, but the final settlement price on the Last Trading Day when the contract expires, is known as the Exchange Delivery Settlement Price (EDSP).

Futures (and options) can be used for three main purposes: hedging, speculating, and arbitraging. A hedger uses the market to offset, cover, or protect, either an actual underlying position, or a perceived requirement. A true hedger therefore, does not seek to profit from a hedge, but simply takes a position as a form of insurance, to cover a position in one market, or product, with an equal and opposite position in another. A “perfect hedge” should therefore result in a profit in one position being fully offset by an equal and opposite loss in the other. In general, protection against a fall in interest rates can be achieved by buying futures; i.e., a so-called “long” hedge. Protection against a rise in interest rates can be achieved by selling futures, i.e., a so-called “short” hedge.

A speculator uses the STIR market to simply “buy low” and “sell high” or vice versa, thereby hoping to make a profit from the difference in price. A speculator therefore has no real need of the underlying product concerned and can speculate on any contract. However, speculators perform the useful purpose of providing much needed liquidity (i.e., a plurality of buyers and sellers at any given price) to any futures contract.

Products that have identical characteristics and so are perfect substitutes for each other should theoretically trade at the same price. If they do not, a risk-free profit can be obtained by simultaneously selling the higher-priced one and buying the lower-priced one. An arbitrageue is therefore someone who uses the markets to take advantage of pricing anomalies that may occur. Such an anomaly could occur between two inter-related products on an exchange, or between two inter-related products on two different exchanges, or between an exchange-traded product and the same product trading in the OTC market. Importantly, with respect to arbitrage, it can only be defined as “pure” arbitrage if both sides of the transaction are dealt simultaneously (i.e., there is no risk at any time). Any delay involved, such as, for example, waiting for one side to move more than the other, is known in the markets as “legging risk” or “lifting a leg”. These delay scenarios are not pure arbitrage, because an element of risk has thereby been introduced.

### SUMMARY OF THE INVENTION

In one aspect, the invention provides a system for facilitating trading of a plurality of financial derivative products. A first product of the plurality of products includes at least four consecutive quarterly deliveries of a short term interest rate (STIR) futures contract. The system includes a server at which each financial derivative product is actively traded, and an interface in communication with the server. The interface is configured to enable a user to buy or sell a financial product. The server is configured to receive bids and offers for a first product via the interface, and to receive bids and offers for individual quarterly deliveries of the STIR futures contract. The server is further configured to automatically combine received bids and offers into sets of at least four consecutive quarterly deliveries, automatically match a result of the combination with a bid or offer for the first product, execute a trade based on the match, and automatically distribute information relating to each of the individual quarterly deliveries included in the executed trade.

The plurality of financial derivative products may include a second product. The second product may include at least four consecutive quarterly deliveries of the STIR futures contract which occur within one of a plurality of predetermined delivery years. The server may be further configured to receive bids or offers for the second product, automatically match a result of the combination with a bid or offer for the second product, execute a trade based on the match, and automatically distribute information relating to each of the individual quarterly deliveries included in the executed trade.

The plurality of financial derivative products may include third, fourth, fifth, and/or sixth products. The third, fourth, fifth, and sixth products may respectively include exactly eight, twelve, sixteen, and twenty consecutive quarterly deliveries of the STIR futures contract, wherein a date of the first quarterly delivery coincides with the first possible quarterly delivery date after the date of the bid or offer. The server may be further configured to receive bids or offers for the third, fourth, fifth, and/or sixth product, automatically match a result of the combination with a bid or offer for the third, fourth, fifth, or sixth product, execute a trade based on the match, and automatically distribute information relating to each of the individual quarterly deliveries included in the executed trade.

The server may include a server computer residing on a network. The interface may include a network connection through which a client computer can access the server computer. The network may be the Internet.

In another aspect, the invention provides a system for facilitating trading of a plurality of financial derivative products. A first product of the plurality of financial derivative products includes at least four quarterly deliveries of a short term interest rate (STIR) futures contract. The system includes a server at which each financial derivative product is actively traded, and an interface in communication with the server. The interface is configured to enable a user to buy or sell a financial product. The server is configured to receive bids and offers for a first product via the interface. A bid for a first product includes a bid to purchase a first quarterly delivery having a first delivery date; an offer to sell a second quarterly delivery having a second delivery date subsequent to the first delivery date; an offer to sell a third quarterly delivery having a third delivery date subsequent to the second delivery date; and a bid to purchase a fourth quarterly delivery having a fourth delivery date subsequent to the third delivery date. The server is further configured to receive bids and offers for individual quarterly deliveries of the STIR futures contract, and to automatically combine received bids and offers into sets of four quarterly deliveries, automatically match a result of the combination with a bid or offer for the first product, execute a trade based on the match, and automatically distribute information relating to each of the individual quarterly deliveries included in the executed trade.

The server may include a server computer residing on a network. The interface may include a network connection through which a client computer can access the server computer. The network may be the Internet.

In yet another aspect of the invention, a method of trading a plurality of financial derivative products in a market is provided. A first product of the plurality of financial derivative products includes at least four consecutive quarterly deliveries of a short term interest rate (STIR) futures contract. The method includes the steps of: enabling a user to submit at least one of a bid and an offer for a first product; enabling bids and offers to be received for individual quarterly deliveries of the STIR futures contract; automatically combining received bids and offers for individual quarterly deliveries into sets of at least four consecutive quarterly deliveries; automatically matching a result of the combining step with a submitted bid or offer for the first product; executing a trade based on the match; and automatically distributing information relating to each of the individual quarterly deliveries included in the executed trade.

The plurality of financial derivative products may include a second product. The second product may include at least four consecutive quarterly deliveries of the STIR futures contract which occur within one of a plurality of predetermined delivery years. The method may further include the steps of enabling a user to submit at least one of a bid and an offer for a second product, automatically matching a result of the combining step with a submitted bid or offer for the second product, executing a trade based on the match, and automatically distributing information relating to each of the individual quarterly deliveries included in the executed trade.

The plurality of financial derivative products may include third, fourth, fifth, and/or sixth products. The third, fourth, fifth, and sixth products may respectively include exactly eight, twelve, sixteen, and twenty consecutive quarterly deliveries of the STIR futures contract, wherein a date of the first quarterly delivery coincides with the first possible quarterly delivery date after the date of the bid or offer. The method may further include the steps of enabling a user to submit at least one of a bid and an offer for a third, fourth, fifth, and/or sixth product, automatically matching a result of the combining step with a submitted bid or offer for the third, fourth, fifth, or sixth product, executing a trade based on the match, and automatically distributing information relating to each of the individual quarterly deliveries included in the executed trade.

A server computer residing on a network may be configured to perform the steps of automatically combining, matching, executing, and distributing. The server computer may be operably connected to an interface through which a client computer can access the server computer via the network. The network may be the Internet.

In still another aspect, the invention provides a method of trading a plurality of financial derivative products in a market. A first product of the plurality of financial derivative products includes at least four quarterly deliveries of a short term interest rate (STIR) futures contract. The method includes the steps of enabling a user to submit at least one of a bid and an offer for a first product; enabling bids and offers to be received for individual quarterly deliveries of the STIR futures contract; automatically combining received bids and offers for individual quarterly deliveries into sets of at least four consecutive quarterly deliveries; automatically matching a result of the combining step with a submitted bid or offer for the first product; executing a trade based on the match; and automatically distributing information relating to each of the individual quarterly deliveries included in the executed trade. A bid for a first product includes a bid to purchase a first quarterly delivery having a first delivery date, an offer to sell a second quarterly delivery having a second delivery date subsequent to the first delivery date, an offer to sell a third quarterly delivery having a third delivery date subsequent to the second delivery date, and a bid to purchase a fourth quarterly delivery having a fourth delivery date subsequent to the third delivery date.

A server computer residing on a network may be configured to perform the steps of automatically combining, matching, executing, and distributing. The server computer may be operably connected to an interface through which a client computer can access the server computer via the network. The network may be the Internet.

In yet another aspect, the invention provides a storage medium for storing software for facilitating trading of a plurality of financial derivative products in a market. A first product of the plurality of financial derivative products includes at least four consecutive quarterly deliveries of a short term interest rate (STIR) futures contract. The software is computer-readable. The software includes instructions for causing a computer to enable a user to submit at least one of a bid and an offer for a first product; enable bids and offers to be received for individual quarterly deliveries of the STIR futures contract; combine received bids and offers for individual quarterly deliveries into sets of at least four consecutive quarterly deliveries; match a result of the combining step with a submitted bid or offer for the first product; execute a trade based on the match; and distribute information relating to each of the individual quarterly deliveries included in the executed trade.

The plurality of financial derivative products may include a second product. The second product may include at least four consecutive quarterly deliveries of the STIR futures contract which occur within one of a plurality of predetermined delivery years. The software may further include instructions for causing a computer to enable a user to submit a bid or offer for a second product, match a result of the combining step with a submitted bid or offer for the second product, execute a trade based on the match, and distribute information relating to each of the individual quarterly deliveries included in the executed trade.

The plurality of financial derivative products may include third, fourth, fifth, and/or sixth products. The third, fourth, fifth, and sixth products may respectively include exactly eight, twelve, sixteen, and twenty consecutive quarterly deliveries of the STIR futures contract, wherein a date of the first quarterly delivery coincides with the first possible quarterly delivery date after the date of the bid or offer. The software may further include instructions for causing a computer to enable a user to submit a bid or offer for a third, fourth, fifth, and/or sixth product, match a result of the combining step with a submitted bid or offer for the third, fourth, fifth, or sixth product, execute a trade based on the match, and distribute information relating to each of the individual quarterly deliveries included in the executed trade.

In still another aspect, the invention provides a storage medium for storing software for facilitating trading of a plurality of financial derivative products in a market. A first product of the plurality of financial derivative products includes at least four consecutive quarterly deliveries of a short term interest rate (STIR) futures contract. The software is computer-readable. The software includes instructions for causing a computer to enable a user to submit a bid or offer for a first product; enable bids and offers to be received for individual quarterly deliveries of the STIR futures contract; combine received bids and offers for individual quarterly deliveries into sets of at least four consecutive quarterly deliveries; match a result of the combining step with a submitted bid or offer for the first product; execute a trade based on the match; and distribute information relating to each of the individual quarterly deliveries included in the executed trade. A bid for a first product includes a bid to purchase a first quarterly delivery having a first delivery date, an offer to sell a second quarterly delivery having a second delivery date subsequent to the first delivery date, an offer to sell a third quarterly delivery having a third delivery date subsequent to the second delivery date, and a bid to purchase a fourth quarterly delivery having a fourth delivery date subsequent to the third delivery date.

### BRIEF DESCRIPTION OF THE DRAWINGS

FIG. 1 illustrates an exemplary forward/forward curve used for tracking interest rate futures.

FIG. 2 illustrates a block diagram of a system for facilitating trading of STIR futures according to a preferred embodiment of the invention.

FIG. 3 is a flow chart that illustrates a method of trading STIR futures according to a preferred embodiment of the invention.

### DETAILED DESCRIPTION OF THE INVENTION

“Implied-in” strips, packs, bundles and condors are trading strategies, which allow a user to buy or sell several futures contract months, or “legs”, in a single transaction. Derivatives products, which are typically made up of a large number of contracts months (e.g., Short Term Interest Rate (STIR) futures), add real value to large users of the market when they offer trading in strips, packs and bundles, as they allow a long term interest rate futures position to be taken, without undertaking the cost and risk of buying or selling each of the individual contract months—known in the market as “legging risk”. In addition, if market makers are encouraged to submit bids and offers into the pack and bundle markets, often the prices achieved by purchasing a pack or bundle are better than those achieved by buying the individual legs.

The present invention links the price relationships between the legs and the strategy markets, such that changes in the prices of the legs, will imply in tradeable strategies in strips, packs, bundles and condors, and make them available for trading in an anonymous electronic market. This will ensure that a fair and orderly market is maintained, particularly during times of high volatility, between the strategy and outright markets. More importantly, the present invention creates a strategy market which can be directly traded, where previously one may not have existed.

The vast majority of strip, pack, bundle and condor trading takes place in “Open Outcry” trading in physical trading pits. Calculating and disseminating implied-in strip, pack, bundle, and condor prices will make their transition to electronic futures trading a smoother and more natural process, bringing the benefits of electronic trading to a wider audience: global price distribution, lower costs, and greater liquidity for the entire market.

An electronic trading platform, or exchange, may allow market participants to submit orders for STIR futures in the form of individual contract months, also referred to as “outrights”. In addition, an exchange may allow market participants to submit an order as a complete strategy—i.e., a combination of two or more contract months, which are also referred to as “legs”. Those strategies are then quoted in the market as an entire strategy.

For futures contracts in which many different delivery months are available to trade, strategy trading is particularly useful to hedgers. This is because taking a completely hedged position may often involve buying or selling multiple contract months to achieve exposure over a number of years. In general, it is far more efficient to perform these kind of “multi-legged” trades by utilizing the strategy markets.

For example, LIFFE CONNECT®, the trading platform used by Euronext.liffe, currently makes the following trading strategies available for trading STIR futures:
Calendar Spread: Buy one contract in the near month; sell one contract in the far month.
Butterfly: Buy one contract in near month, sell two contracts in the far month, buy one contract in a yet farther month. The gaps between the months do not have to be equal or consecutive.
Condor: Buy one near contract month, sell one far month, sell one further month and buy one still further month. The gaps between the months do not have to be equal or consecutive.
Strip: Buy four or more consecutive quarterly delivery months. Any quarterly delivery month can act as the first month of the strip, so long as there are at least three following months available. Serial months in a contract are ignored and cannot form part of a strip. The number of lots in each leg can vary. Selling the strip involves selling all months in the strip, and vice versa for buying.
Pack: Buy four quarterly delivery months in the same delivery year. LIFFE CONNECT® currently recognizes five packs: White Pack, Red Pack, Green Pack, Blue Pack and Gold Pack. The first month of the White Pack is always the front quarterly month (i.e., the earliest possible future quarterly month). The following packs (i.e., Red, Green, Blue and Gold) must also start with the same quarterly month in following years. The number of lots in each leg of a pack must always be the same.
Bundle: Buy a series of quarterly delivery months of a contract where the first contract in any bundle is the front (i.e., earliest-dated) quarterly delivery month. A bundle is a consecutive series of packs. The first month of a bundle is always the front quarterly month. The number of lots in each leg must be the same. LIFFE CONNECT® currently recognizes four bundles: 2 Year Bundle, 3 Year Bundle, 4 Year Bundle and 5 Year Bundle.

A major factor in any interest rate market is the yield curve. Trading a particular outright STIR futures delivery month gives the user access to the required section of the yield curve. Packs and bundles strategies offer increased efficiency in gaining exposure to longer-term interest rates and further sections of the yield curve.

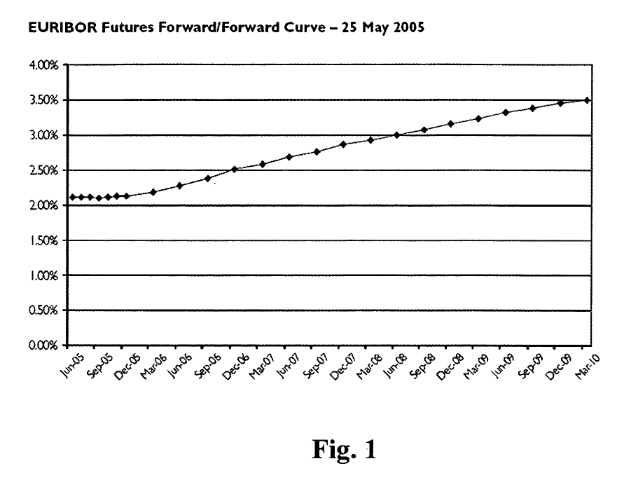

The price quoted for a particular STIR futures outright delivery month implies the market's perception of the official three month LIBOR or EURIBOR fixing on that contract month's last trading day. Because different outright STIR futures delivery months each represent the underlying interest rate at a different point in time, this series of rates does not compose a single forward curve, but instead what is known as a “forward/forward curve”. Whereas a forward curve represents the market's expectation of where the spot yield curve will be at a particular forward date, a forward/forward curve shows the market's expectation of the evolution of a single point on the curve (e.g., the three-month forward rate) over a period of time. The level of interest rates in any domestic market is determined by numerous factors, including, for example, supply and demand, government or central bank monetary policy, the current economic climate, the strength or weakness of the currency, etc. All of these factors can contribute to moving the spot yield curve and the various forward yield curves embedded in the spot yield curve. An example of a forward/forward curve is shown in FIG. 1.

Referring also to Table 2 below, the multiple quarterly delivery months that constitute a bundle form a substantially continuous series of consecutive three month deposit rates out to the specified term. The twenty months comprising the Five Year Bundle, for example, represent twenty consecutive points on a five year forward yield curve. Since different bundles represent different term interest rates that effectively each start on the same day, they do all fall on a single forward curve.

TABLE 2
Eg EURIBOR Bundle Forward Curve on 16 Jun. 2005

| | |
|---|---|
| White | September-2005 December-2005 March-2006 June-2006 |
| Pack | |
| Two | September-2005 December-2005 March 2006 June-2006 |
| Year | September-2006 December-2006 March-2007 June-2007 |
| Bundle | |
| Three | September-2005 December-2005 March 2006 June-2006 |
| Year | September-2006 December-2006 March-2007 June-2007 |
| Bundle | September-2007 December-2007 March-2008 June-2008 |
| Four | September-2005 December-2005 March-2006 June-2006 |
| Year | September-2006 December-2006 March-2007 June-2007 |
| Bundle | September-2007 December-2007 March-2008 June-2008 |
| | September-2008 December-2008 March-2009 June-2009 |
| Five | September-2005 December-2005 March-2006 June-2006 |
| Year | September-2006 December-2006 March-2007 June-2007 |
| Bundle | September-2007 December-2007 March-2008 June-2008 |
| | September-2008 December-2008 March-2009 June-2009 |

Similarly, the interest rates comprising a White Pack also fall on the same forward curve, because the White Pack is essentially the same as a One Year Bundle. However, referring to Table 3 below, because the subsequent packs start at different points in time and cover different sections of the yield curve, the Red, Green, Blue and Gold Packs fall on a forward/forward curve.

TABLE 3
Eg EURIBOR Pack Forward/Forward Curve on 16 Jun. 2005

| | | | | | |
|---|---|---|---|---|---|
| White | September-2005 | | | | |
| Pack | December-2005 | | | | |
| | March-2006 June-2006 | | | | |
| Red | | September-2006 | | | |
| Pack | | December-2006 | | | |
| | | March-2007 June-2007 | | | |
| Green | | | September-2007 | | |
| Pack | | | December-2007 | | |
| | | | March-2008 June-2008 | | |
| Blue | | | | September-2008 | |
| Pack | | | | December-2008 | |
| | | | | March-2009 June-2009 | |
| Gold | | | | | September-2009 |
| Pack | | | | | December-2009 |
| | | | | | March-2010 June-2010 |

It is important to note that, when calculating the long-term interest rate from the series of rates making up the bundle or the White Pack, whether one compounds the various rates or simply takes the average rate, the long term rates generated in both cases are very similar. Referring to Table 4 below, an example is shown:

TABLE 4
Eg EURIBOR White Pack made up of the
following four delivery months:

| | September 2005 | December-2005 | March-2006 | June-2006 |
|---|---|---|---|---|
| time | 91 | 90 | 92 | 92 |
| period | | | | |
| (days) | | | | |
| futures | 97.89 | 97.865 | 97.81 | 97.72 |
| price | | | | |
| deposit | 2.11% | 2.135% | 2.19% | 2.28% |
| rate | | | | |

The compound interest rate would be calculated as follows:
[(1+2.11%×91/360)×(1+2.135%×90/360)×(1+2.19%×92/360)×(1+2.28%×90/360)]×360/365=2.197%
By comparison to this compounded rate of 2.197%, a simple average rate, ignoring day counts, equates to 2.179%.

A Five Year Bundle is effectively a way of gaining exposure in a single transaction to the equivalent of reinvesting twenty times in end-to-end three-month deposits. This, in turn, is a five year deposit rate. Thus, a Five Year Bundle can indicate the market's expectation of five-year interest rates. Because bundles provide access to a longer-term deposit rate, they are effectively bond-like strategies in the way they offer access to a particular term yield curve. Referring to Table 5 below, STIR bundles can therefore be used as an efficient alternative to cash bonds or bond futures for hedging and trading.

TABLE 5
Cash Bond/Bond STIR Bundle Future alternative

| | |
|---|---|
| Two Year Schatz | Two Year EURIBOR Bundle |
| Five Year Bobl | Five Year EURIBOR Bundle |
| Two Year Gilt | Two Year Short Sterling Bundle |
| Five Year Gilt | Five Year Short Sterling Bundle |
| Two Year US Treasury | Two Year Eurodollar Bundle |
| Five Year US Treasury | Five Year Eurodollar Bundle |

By virtue of the use of a series of quarterly futures contracts in their construction, bundles actually offer a superior alternative to bond futures when hedging. For example, where a Bobl future is used to hedge an underlying five year position, the futures position will have an increasing mismatch with the instrument being hedged. By contrast, a Five Year EURIBOR Bundle closely tracks the term of the hedged position—when the instrument being hedged becomes a four-and-a-half year instrument, the expiry of the two front constituent quarterly months in the Five Year Bundle means that it too has a four-and-a-half year term. In addition, such a bond futures hedge position would need to be “rolled” twice (i.e., to “roll” is to move the financial exposure from one contract month to another, as the current contract month moves toward its last trading day) during the five years. Rolling involves closing a position in the contract approaching expiry, and opening the same position in the next contract month, and therefore can be expensive in terms of transaction fees. By contrast, a Five Year Bundle has no such requirement to roll during the lifetime of the hedge.

As with all hedging calculating, the hedge ratio is key. The simplest way to calculate this is via basis point value. Because basis point value reflects the value of the change in price for each 1/100 of a per cent change in yield, it can be used to ensure that the amount of the instrument used to construct the hedge is equivalent to the yield curve exposure of the position to be hedged.

The following is an example of using a Eurodollar Two Year Bundle to hedge a cash Treasury Note: On 31st Mar. 2004, a bond trader buys $10 million of the recently issued 1.5% March 2006 Treasury note at a clean price of 99-26/32. To hedge this position over the next three months, the trader uses a Two Year Eurodollar Bundle. To calculate the appropriate hedge ratio, the trader looks up the basis point value of this particular bond from an appropriate data source and is able to calculate that the basis point value of his cash trade is $1,953. Because one Two Year Bundle has a basis point value of $200 (eight legs×the $25 value of 0.01 for each leg), therefore covering roughly 1/10 of the basis point value of the position to be hedged, the trader simply sells 10 lots of the Eurodollar Two Year Bundle at an average leg price of 97.9275. On 11th Jun. 2004, the clean price of the T-note drops to 97-29.5/32, i.e., a drop of 1-28.5/32 per cent. This would result in a loss of $189,062.50 on the cash bond side of the position, but at the same time, the average leg price of the Two Year Bundle has also fallen. Now, at an average leg price of 96.745, the short bundle position is showing a profit of $236,500, which offsets the loss generated by fall in the value of the long cash bond position. Although a more exact approach would be to apply individual hedge ratios for each contract month forming the constituent legs of the bundle (i.e., a series of eight hedge ratios to cover the two year curve), such an approach is cumbersome and lacks the simplicity, efficiency and ease of execution that are provided by the bundle market.

For bundle users who wish to adjust their hedge to reflect varying hedge ratios, packs are an ideal solution. Packs allow the user to execute an efficient bundle hedge quickly and easily in the strategy market and then, perhaps, to further tailor the hedge by executing a pack trade to adjust the hedge ratio to a particular section of the curve. Referring to Table 6 below, the following scenario is an example of using packs to adjust the hedge ratio of a Five Year Bundle: To hedge a $100 million 5 year swap position, possible hedge ratios for each of the constituent quarterly months might require the following number of lots to be traded at each point on the curve:

TABLE 6

| | Quarter | | | | | | | | | |
|---|---|---|---|---|---|---|---|---|---|---|
| | 1 | 2 | 3 | 4 | 5 | 6 | 7 | 8 | 9 | 10 |
| | Contract Month | | | | | | | | | |
| | September- | December- | March- | June- | September- | December- | March- | June- | September- | December- |
| | 2005 | 2005 | 2006 | 2006 | 2006 | 2006 | 2007 | 2007 | 2007 | 2007 |
| Number of | 102 | 101 | 98 | 97 | 97 | 97 | 94 | 93 | 93 | 93 |
| Futures Lots | | | | | | | | | | |

| | Quarters | | | | | | | | | |
|---|---|---|---|---|---|---|---|---|---|---|
| | 11 | 12 | 13 | 14 | 15 | 16 | 17 | 18 | 19 | 20 |
| | Contract Month | | | | | | | | | |
| | March- | June- | September- | December- | March- | June- | September- | December- | March- | June- |
| | 2008 | 2008 | 2008 | 2008 | 2009 | 2009 | 2009 | 2009 | 2010 | 2010 |
| Number of | 90 | 90 | 90 | 90 | 87 | 86 | 86 | 86 | 83 | 82 |
| Futures Lots | | | | | | | | | | |

To execute each of the 20 constituent legs at these individual volumes would be time-consuming and would involve such a significant amount of legging risk (i.e., the possibility of exposure to trades in the individual contract months taking place at the wrong price, hence invalidating the hedge). Therefore, such a transaction may be rather unreasonable. However, referring to Table 7 below, by using the following numbers of Five Year Bundles and the relevant color packs, the user can achieve a tailored hedge that more closely reflects the declining hedge ratio further along the curve:

TABLE 7

| | Numbers of Strategy Lots | | | | | | | | | | | | | | | | | | | |
|---|---|---|---|---|---|---|---|---|---|---|---|---|---|---|---|---|---|---|---|---|
| | 83 Five Year Bundles | | | | | | | | | | | | | | | | | | | |
| | 17 White Packs | | | | 13 Red Packs | | | | 9 Green Packs | | | | 5 Blue Packs | | | | 0 Gold Packs | | | |
| Futures | 100 | 100 | 100 | 100 | 96 | 96 | 96 | 96 | 92 | 92 | 92 | 92 | 88 | 88 | 88 | 88 | 83 | 83 | 83 | 83 |
| per leg | | | | | | | | | | | | | | | | | | | | |

A bundle is, in effect, a standardized hedge instrument. The importance of packs as an available strategy is that they provide the opportunity to tailor bundle hedges while still offering easy execution of multi-legged strategies in a transparent, efficient strategy market.

In today's financial markets, the vast majority of trading in relatively complex strategies, such as strips, packs, bundles and condors, takes place in the “Open Outcry” environment on the trading floor. Open Outcry trading involves traders physically meeting in the trading pit, and agreeing on prices face-to-face. There is a strong customer demand to make strips, packs, bundles and condors available for trading electronically, rather than via an Open Outcry trading floor. This is due to a number of reasons, including the following:
Electronic markets allow continuous price discovery for all participants, in real time. Open Outcry trading floors, by their very nature, can never distribute prices without a time delay which can impact trading opportunities.
Transparency and Anonymity—in electronic markets, all market participants can view all market prices which are entered by anonymous participants. In Open Outcry trading floors, participants on the trading floor have an inherent advantage in that they are aware of the individuals, and institutions they represent, that have submitted bids and offers into the market.
Cost: Entering orders onto trading floors, particularly for complex multi-legged strategies such as packs and bundles, can attract significant brokerage fees. For example, trading a 5 Year Bundle may constitute paying a brokerage fee on every one of the 20 contract months being purchased. Trading electronically, allows exchanges which offer complex strategy trading to offer enlightened fee schedules such as “per strategy” pricing as opposed to pricing for each individual leg of the strategy.

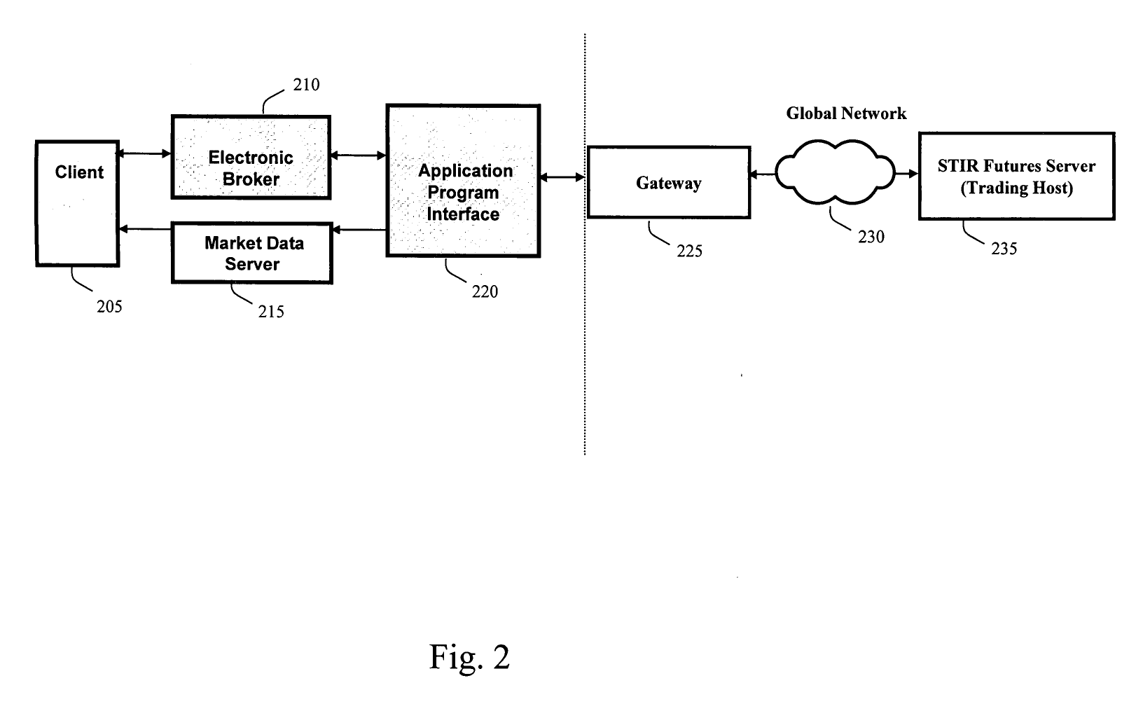

Referring to FIG. 2, a block diagram illustrating an electronic platform 200 for facilitating trading of STIR futures, including strips, packs, bundles, condors, and individual monthly and/or quarterly deliveries of STIR futures, is shown. The electronic platform 200 includes one or more servers 235, also referred to as a trading host, and one or more Application Program Interfaces (API) 220. The API 220 is an interface that enables a user, such as a broker or a customer, to access the STIR futures market. The user generally accesses the API 220 by using a client computer 205, which is connected to the API 220 via an electronic broker module 210. The API 220 is connected to the trading host 235 via a gateway 225, i.e., a server-side interface to a network 230, such as the Internet. The trading host 235 receives bids and offers submitted via an API 220 and then executes trades, as further described below. The trading host 235 also passes market data back to the users via the API 220 and a market data server module 210.

The trading host 235 is preferably implemented by the use of one or more general purpose computers, such as, for example, a Sun Microsystems F15k. Each API 220 is also preferably implemented by the use of one or more general purpose computers, such as, for example, a typical personal computer manufactured by Dell, Gateway, or Hewlett-Packard. Each of the trading host 235 and the API 220 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. Each of the trading host 235 and the API 220 can also include computer memory, such as, for example, random-access memory (RAM). However, the computer memory of each of the trading host 235 and the API 220 can be any type of computer memory or any other type of electronic storage medium that is located either internally or externally to the trading host 235 or the API 220, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the trading host 235 or the API 220. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 235 and the API 220 can also include a database. The database can be any type of computer database for storing, maintaining, and allowing access to electronic information stored therein. The trading host 235 preferably resides on a network, such as a local area network (LAN), a wide area network (WAN), or the Internet. The API 220 preferably is connected to the network on which the host server resides, thus enabling electronic communications between the trading host 235 and the API 220 over a communications connection, whether locally or remotely, such as, for example, an Ethernet connection, an RS-232 connection, or the like.

One of the great barriers to migrating complex strategy trading to an electronic platform 200 is that many strategies are generated by “implied” prices. Implied orders are synthetic orders that are generated as a result of the interaction of explicit orders. Implied trading functionality increases liquidity and improves trading opportunities. There are two different forms of implieds—implied-ins and implied-outs. For explicit strategy markets where implied trading functionality applies, the relevant outright contract months can generate implied-in prices into strategy markets. Where these implied-in prices represent the best price for a strategy, they may be traded subject to the trade matching algorithm. The interaction of an explicit strategy order and an outright order can generate an implied-out price in another outright market. Where an implied-out price generated by the trading host 235 represents the best price for the outright contract month, the order will be traded subject to the trading algorithm.

An example of an implied-in calendar spread is shown in Table 8 below:

TABLE 8

Month

| | December | March | December/March Strategy |
|---|---|---|---|
| Bid | 95.000 | | −0.100 |
| | | | Implied |
| Ask | | 95.100 | |

The purchase of a December/March spread is the equivalent of buying a December quarterly delivery and selling a March quarterly delivery. In this example, two explicit orders are entered. This creates an implied-in strategy bid in December/March of −0.100. This price is calculated and held in the trading host 235. An incoming strategy that is entered and matches this price will automatically trade against the explicit outright legs that formed the implied strategy.

As described above, implied-in prices are strategy prices implied into the relevant strategy market based on orders in the outright markets which constitute the strategy's legs. The use of implied-in prices will have the effect of increasing liquidity in the strategy market, because strategy orders that are directly entered will then trade with strategy orders which have been generated by the host from the more numerous outright orders.

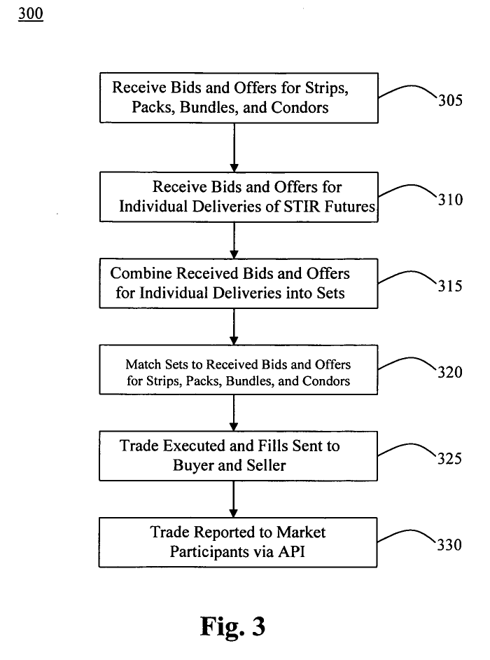

Referring to FIG. 3, a flow chart 300 illustrates a process of facilitating trading between strategy orders and individual STIR quarterly deliveries using implied-in prices according to a preferred embodiment of the invention. At step 305, the trading host receives bids and offers for strategy orders, such as strips, packs, bundles, and/or condors. At step 310, the trading host receives bids and offers for individual quarterly (or monthly) deliveries of STIR futures. The trading host is generally performing both of steps 305 and 310 on an ongoing basis. Then, at step 315, received bids and offers for individual deliveries are combined into sets that can be matched to strategy orders, thereby implying in prices for the relevant set. At step 320, the implied in prices for the combined sets are matched to the corresponding strategy order. At step 325, the trade is executed, generally by cash settlement. In addition, when a trade is executed, quarterly delivery month “fills” are sent to the buyer and the seller, similarly as in the example shown in Table 8 above. Finally, at step 330, the executed trade is reported to all market participants via their respective APIs 220.

A number of examples of the process 300 are given below, using typical prices that may be quoted in the marketplace. Futures contracts are typically priced in “ticks”—i.e., the minimum price movement of the product. The value of a tick varies, depending on the specifications of the individual product.

Buying a futures strip is defined as buying four or more consecutive quarterly deliveries in the same STIR contract. The legs of a strip are priced relative to the previous day's settlement price. If it is the contract's first day of trading, a settlement price of zero is used. Furthermore, the ratio of each leg is ignored when calculating the strategy price. Therefore, the price of the strip may be calculated as follows:
Price=(Leg1−Settlement Price1)+(Leg2−Settlement Price2) . . . +(Legn−Settlement Pricen)

For example, using the data from Table 9 below, an implied-in strip price may be generated:

TABLE 9

| | September | | December | | March | | June | |
|---|---|---|---|---|---|---|---|---|
| Ask | | 95.010 | | 95.020 | | 95.030 | | 95.055 |
| Bid | 95.005 | | 95.015 | | 95.025 | | 95.050 | |
| Settlement | | 94.940 | | 94.945 | | 94.955 | | 94.960 |

With the outright market in the state shown above, the trading host may calculate an implied-in bid of 0.295 and an implied-in offer of 0.315 in response to orders entered into the Sep-Dec-Mar-Jun strip market. This price would be calculated as follows:
(95.005B−94.940)+(95.015B−94.945)+(95.025B−94.955)+(95.050B−94.960)=0.295B
And: (95.010A−94.940)+(95.020A−94.945)+(95.030A−94.955)+(95.055A−94.960)=0.315A

Buying a futures pack is defined as buying a defined set of four consecutive delivery months. Whereas strips can contain any listed delivery months above four quarterly expiries, packs are pre-defined strategies on the LIFFE CONNECT® platform. The pack must comprise four consecutive quarterly deliveries, and have a standard color coding, as shown in Table 10 below:

TABLE 10

| PACK | LEGS |
|---|---|
| White | September 2005 - December 2005 - March 2006 - June 2006 |
| Red | September 2006 - December 2006 - March 2007 - June 2007 |
| Green | September 2007 - December 2007 - March 2008 - June 2008 |
| Blue | September 2008 - December 2008 - March 2009 - June 2009 |
| Gold | September 2009 - December 2009 - March 2010 - June 2010 |

The calculations for implied-in pricing for a pack are exactly the same for a strip.

Buying a futures bundle is defined as buying two or more consecutive packs. Each pack must be valid according to the rules specified above. The first pack must always be the White Pack. LIFFE CONNECT®, the trade matching engine used by Euronext.liffe, defines four valid bundles at any one time. Table 11 below lists the current four:

TABLE 11

| BUNDLE | DURATION | NO. LEGS |
|---|---|---|
| White - Red | September 2005-June 2007 | 8 |
| White - Red - Green | September 2005-June 2008 | 12 |
| White - Red - Green - Blue | September 2005-June 2009 | 16 |
| White - Red - Green - Blue - | September 2005-June 2010 | 20 |
| Gold | | |

While it is convenient to describe the bundle as comprising a number of packs, it is implemented as a collection of outright legs like any other strategy. The legs of a bundle are priced relative to the previous day's settlement price, and leg ratios are ignored for pricing purposes. Bundles are therefore priced according to the same formula as the strip and pack. An exemplary calculation of an implied-in price for a bundle is provided using Table 12 below:

TABLE 12

| | September 2004 | | December 2004 | | March 2005 | | June 2005 | |
|---|---|---|---|---|---|---|---|---|
| Ask | | 95.010 | | 95.020 | | 95.030 | | 95.055 |
| Bid | 95.005 | | 95.015 | | 95.025 | | 95.050 | |
| Settlement | | 94.940 | | 94.945 | | 94.955 | | 94.960 |
| | September 2005 | | December 2005 | | March 2006 | | June 2006 | |
| Ask | | 95.070 | | 95.075 | | 95.085 | | 95.090 |
| Bid | 95.060 | | 95.070 | | 95.080 | | 95.085 | |
| Settlement | | 94.970 | | 94.975 | | 95.005 | | 95.015 |

The above market could create an implied in bid of 0.625 and an implied in offer of 0.670. This implied-in price is calculated as follows:
Bid: (95.005B−94.940)+(95.015B−94.945)+(95.025B−94.955)+(95.050B−94.960)+(95.060B−94.970)+(95.070B−94.975)+(95.080B−95.005)+(95.085B−95.015)=0.625B
Offer: (95.010A−94.940)+(95.020A−94.945)+(95.030A−94.955)+(95.055A−94.960)+(95.070A−94.970)+(95.075A−94.975)+(95.085A−95.005)+(95.090A−95.015)=0.670A

As described above, buying a condor future is defined as: (1) buying a STIR future; (2) selling a STIR future with later delivery month than (1); (3) selling a STIR future with later delivery month than (2); and (4) buying a STIR future with later delivery month than (3). There are no additional restrictions on the distribution of the delivery months. The strategy is priced as follows: Price=Leg1−Leg2−Leg3+Leg4. An example of an implied-in price for a condor is provided with reference to Table 13 below:

TABLE 13

| | September | | October | | November | | December | |
|---|---|---|---|---|---|---|---|---|
| Ask | | 95.010 | | 95.020 | | 95.030 | | 95.055 |
| Bid | 95.005 | | 95.015 | | 95.025 | | 95.050 | |

The above market could create an implied -in bid price of 0.005 and an implied offer price of 0.025 in the Sep-Oct-Nov-Dec condor market, calculated as follows:
Bid: 95.005B−95.020A−95.030A+95.050B=0.005B
Offer: 95.010A−95.015B−95.025B+95.055A=0.025A

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A system for facilitating trading of a plurality of financial derivative products, a first product of the plurality of financial products comprising at least four consecutive quarterly deliveries of a short term interest rate (STIR) futures contract, and the system comprising:
a server at which each financial product is actively traded; and
an interface in communication with the server, the interface being configured to enable a user to at least one of buy and sell a financial product,
wherein the server is configured to receive bids and offers for a first product via the interface, and
wherein the server is further configured to receive bids and offers for individual quarterly deliveries of the STIR futures contract; and
wherein the server is further configured to:
combine received bids and offers into sets of at least four consecutive quarterly deliveries;
match a result of the combination with a bid or offer for the first product;
execute a trade based on the match; and
distribute information relating to each of the individual quarterly deliveries included in the executed trade.

2. The system of claim 1, wherein the plurality of financial products includes a second product, the second product comprising at least four consecutive quarterly deliveries of the STIR futures contract which occur within one of a plurality of predetermined delivery years, and
wherein the server is further configured to:
receive bids or offers for the second product;
match a result of the combination with a bid or offer for the second product;
execute a trade based on the match; and
distribute information relating to each of the individual quarterly deliveries included in the executed trade.

3. The system of claim 1, wherein the plurality of financial products includes a third product, the third product comprising exactly eight consecutive quarterly deliveries of the STIR futures contract, wherein a date of the first quarterly delivery coincides with the first possible quarterly delivery date after the date of the bid or offer, and
wherein the server is further configured to:
receive bids or offers for the third product;
match a result of the combination with a bid or offer for the third product;
execute a trade based on the match; and
distribute information relating to each of the individual quarterly deliveries included in the executed trade.

4. The system of claim 1, wherein the plurality of financial products includes a fourth product, the fourth product comprising exactly twelve consecutive quarterly deliveries of the STIR futures contract, wherein a date of the first quarterly delivery coincides with the first possible quarterly delivery date after the date of the bid or offer, and
wherein the server is further configured to:
receive bids or offers for the fourth product;
match a result of the combination with a bid or offer for the fourth product;
execute a trade based on the match; and
distribute information relating to each of the individual quarterly deliveries included in the executed trade.

5. The system of claim 1, wherein the plurality of financial products includes a fifth product, the fifth product comprising exactly sixteen consecutive quarterly deliveries of the STIR futures contract, wherein a date of the first quarterly delivery coincides with the first possible quarterly delivery date after the date of the bid or offer, and
wherein the server is further configured to:
receive bids or offers for the fifth product;
match a result of the combination with a bid or offer for the fifth product;
execute a trade based on the match; and
distribute information relating to each of the individual quarterly deliveries included in the executed trade.

6. The system of claim 1, wherein the plurality of financial products includes a sixth product, the sixth product comprising exactly twenty consecutive quarterly deliveries of the STIR futures contract, wherein a date of the first quarterly delivery coincides with the first possible quarterly delivery date after the date of the bid or offer, and
wherein the server is further configured to:
receive bids or offers for the sixth product;
match a result of the combination with a bid or offer for the sixth product;
execute a trade based on the match; and
distribute information relating to each of the individual quarterly deliveries included in the executed trade.

7. The system of claim 1, wherein the server comprises a server computer residing on a network, and the interface comprises a network connection through which a client computer can access the server computer.

8. The system of claim 7, wherein the network is the Internet.

9. A system for facilitating trading of a plurality of financial derivative products, the plurality of financial products including a first product comprising at least four quarterly deliveries of a short term interest rate (STIR) futures contract, and the system comprising:
a server at which each financial product is actively traded; and
an interface in communication with the server, the interface being configured to enable a user to at least one of buy and sell a financial product,
the server being configured to receive bids and offers for a first product via the interface, wherein a bid for a first product comprises:
a bid to purchase a first quarterly delivery having a first delivery date;
an offer to sell a second quarterly delivery having a second delivery date subsequent to the first delivery date;
an offer to sell a third quarterly delivery having a third delivery date subsequent to the second delivery date; and
a bid to purchase a fourth quarterly delivery having a fourth delivery date subsequent to the third delivery date,
wherein the server is further configured to receive bids and offers for individual quarterly deliveries of the STIR futures contract; and
wherein the server is further configured to:
combine received bids and offers into sets of four quarterly deliveries;
match a result of the combination with a bid or offer for the first product;
execute a trade based on the match; and
distribute information relating to each of the individual quarterly deliveries included in the executed trade.

10. The system of claim 9, wherein the server comprises a server computer residing on a network, and the interface comprises a network connection through which a client computer can access the server computer.

11. The system of claim 10, wherein the network is the Internet.

12. A method of trading a plurality of financial derivative products in a market, a first product of the plurality of financial products comprising at least four consecutive quarterly deliveries of a short term interest rate (STIR) futures contract, and the method comprising the steps of:
enabling a user to submit at least one of a bid and an offer for a first product;
enabling bids and offers to be received for individual quarterly deliveries of the STIR futures contract;
combining received bids and offers for individual quarterly deliveries into sets of at least four consecutive quarterly deliveries;
matching a result of the combining step with a submitted bid or offer for the first product;
executing a trade based on the match; and
distributing information relating to each of the individual quarterly deliveries included in the executed trade.

13. The method of claim 12, wherein the plurality of financial products includes a second product, the second product comprising at least four consecutive quarterly deliveries of the STIR futures contract which occur within one of a plurality of predetermined delivery years, and wherein the method further includes the steps of:
enabling a user to submit at least one of a bid and an offer for a second product;
matching a result of the combining step with a submitted bid or offer for the second product;
executing a trade based on the match; and
distributing information relating to each of the individual quarterly deliveries included in the executed trade.

14. The method of claim 12, wherein the plurality of financial products includes a third product, the third product comprising exactly eight consecutive quarterly deliveries of the STIR futures contract, wherein a date of the first quarterly delivery coincides with the first possible quarterly delivery date after the date of the bid or offer, and wherein the method further includes the steps of:
enabling a user to submit at least one of a bid and an offer for a third product;
matching a result of the combining step with a submitted bid or offer for the third product;
executing a trade based on the match; and
distributing information relating to each of the individual quarterly deliveries included in the executed trade.

15. The method of claim 12, wherein the plurality of financial products includes a fourth product, the fourth product comprising exactly twelve consecutive quarterly deliveries of the STIR futures contract, wherein a date of the first quarterly delivery coincides with the first possible quarterly delivery date after the date of the bid or offer, and wherein the method further includes the steps of:
enabling a user to submit at least one of a bid and an offer for a fourth product;
matching a result of the combining step with a submitted bid or offer for the fourth product;
executing a trade based on the match; and
distributing information relating to each of the individual quarterly deliveries included in the executed trade.

16. The method of claim 12, wherein the plurality of financial products includes a fifth product, the fifth product comprising exactly sixteen consecutive quarterly deliveries of the STIR futures contract, wherein a date of the first quarterly delivery coincides with the first possible quarterly delivery date after the date of the bid or offer, and wherein the method further includes the steps of:
enabling a user to submit at least one of a bid and an offer for a fifth product;
matching a result of the combining step with a submitted bid or offer for the fifth product;
executing a trade based on the match; and
distributing information relating to each of the individual quarterly deliveries included in the executed trade.

17. The method of claim 12, wherein the plurality of financial products includes a sixth product, the sixth product comprising exactly twenty consecutive quarterly deliveries of the STIR futures contract, wherein a date of the first quarterly delivery coincides with the first possible quarterly delivery date after the date of the bid or offer, and wherein the method further includes the steps of:
enabling a user to submit at least one of a bid and an offer for a sixth product;
matching a result of the combining step with a submitted bid or offer for the sixth product;
executing a trade based on the match; and
distributing information relating to each of the individual quarterly deliveries included in the executed trade.

18. The method of claim 12, wherein a server computer residing on a network is configured to perform the steps of combining, matching, executing, and distributing, the server computer being operably connected to an interface through which a client computer can access the server computer via the network.

19. The method of claim 18, wherein the network is the Internet.

20. A method of trading a plurality of financial derivative products in a market, a first product of the plurality of financial products comprising at least four quarterly deliveries of a short term interest rate (STIR) futures contract, and the method comprising the steps of:
enabling a user to submit at least one of a bid and an offer for a first product;
enabling bids and offers to be received for individual quarterly deliveries of the STIR futures contract;
combining received bids and offers for individual quarterly deliveries into sets of at least four consecutive quarterly deliveries;
matching a result of the combining step with a submitted bid or offer for the first product;
executing a trade based on the match; and
distributing information relating to each of the individual quarterly deliveries included in the executed trade,
wherein a bid for a first product comprises a bid to purchase a first quarterly delivery having a first delivery date, an offer to sell a second quarterly delivery having a second delivery date subsequent to the first delivery date, an offer to sell a third quarterly delivery having a third delivery date subsequent to the second delivery date, and a bid to purchase a fourth quarterly delivery having a fourth delivery date subsequent to the third delivery date.

21. The method of claim 20, wherein a server computer residing on a network is configured to perform the steps of combining, matching, executing, and distributing, the server computer being operably connected to an interface through which a client computer can access the server computer via the network.

22. The method of claim 21, wherein the network is the Internet.

23. A storage medium for storing software for facilitating trading of a plurality of financial derivative products in a market, a first product of the plurality of financial products comprising at least four consecutive quarterly deliveries of a short term interest rate (STIR) futures contract, the software being computer-readable, wherein the software includes instructions for causing a computer to:
enable a user to submit at least one of a bid and an offer for a first product;
enable bids and offers to be received for individual quarterly deliveries of the STIR futures contract;
combine received bids and offers for individual quarterly deliveries into sets of at least four consecutive quarterly deliveries;
match a result of the combining step with a submitted bid or offer for the first product;
execute a trade based on the match; and
distribute information relating to each of the individual quarterly deliveries included in the executed trade.

24. The storage medium of claim 23, wherein the plurality of financial products includes a second product, the second product comprising at least four consecutive quarterly deliveries of the STIR futures contract which occur within one of a plurality of predetermined delivery years, and wherein the software further includes instructions for causing a computer to:
enable a user to submit at least one of a bid and an offer for a second product;
match a result of the combining step with a submitted bid or offer for the second product;
execute a trade based on the match; and
distribute information relating to each of the individual quarterly deliveries included in the executed trade.

25. The storage medium of claims 23, wherein the plurality of financial products includes a third product, the third product comprising exactly eight consecutive quarterly deliveries of the STIR futures contract, wherein a date of the first quarterly delivery coincides with the first possible quarterly delivery date after the date of the bid or offer, and wherein the software further includes instructions for causing a computer to:
enable a user to submit at least one of a bid and an offer for a third product;
match a result of the combining step with a submitted bid or offer for the third product;
execute a trade based on the match; and
distribute information relating to each of the individual quarterly deliveries included in the executed trade.

26. The storage medium of claim 23, wherein the plurality of financial products includes a fourth product, the fourth product comprising exactly twelve consecutive quarterly deliveries of the STIR futures contract, wherein a date of the first quarterly delivery coincides with the first possible quarterly delivery date after the date of the bid or offer, and wherein the software further includes instructions for causing a computer to:
enable a user to submit at least one of a bid and an offer for a fourth product;
match a result of the combining step with a submitted bid or offer for the fourth product;
execute a trade based on the match; and
distribute information relating to each of the individual quarterly deliveries included in the executed trade.

27. The storage medium of claim 23, wherein the plurality of financial products includes a fifth product, the fifth product comprising exactly sixteen consecutive quarterly deliveries of the STIR futures contract, wherein a date of the first quarterly delivery coincides with the first possible quarterly delivery date after the date of the bid or offer, and wherein the software further includes instructions for causing a computer to:
enable a user to submit at least one of a bid and an offer for a fifth product;
match a result of the combining step with a submitted bid or offer for the fifth product;
execute a trade based on the match; and
distribute information relating to each of the individual quarterly deliveries included in the executed trade.

28. The storage medium of claim 23, wherein the plurality of financial products includes a sixth product, the sixth product comprising exactly twenty consecutive quarterly deliveries of the STIR futures contract, wherein a date of the first quarterly delivery coincides with the first possible quarterly delivery date after the date of the bid or offer, and wherein the software further includes instructions for causing a computer to:
enable a user to submit at least one of a bid and an offer for a sixth product;
match a result of the combining step with a submitted bid or offer for the sixth product;
execute a trade based on the match; and
distribute information relating to each of the individual quarterly deliveries included in the executed trade.

29. A storage medium for storing software for facilitating trading of a plurality of financial derivative products in a market, a first product of the plurality of financial products comprising at least four consecutive quarterly deliveries of a short term interest rate (STIR) futures contract, the software being computer-readable, wherein the software includes instructions for causing a computer to:
enable a user to submit at least one of a bid and an offer for a first product;
enable bids and offers to be received for individual quarterly deliveries of the STIR futures contract;
combine received bids and offers for individual quarterly deliveries into sets of at least four consecutive quarterly deliveries;
match a result of the combining step with a submitted bid or offer for the first product;
execute a trade based on the match; and
distribute information relating to each of the individual quarterly deliveries included in the executed trade,
wherein a bid for a first product comprises a bid to purchase a first quarterly delivery having a first delivery date, an offer to sell a second quarterly delivery having a second delivery date subsequent to the first delivery date, an offer to sell a third quarterly delivery having a third delivery date subsequent to the second delivery date, and a bid to purchase a fourth quarterly delivery having a fourth delivery date subsequent to the third delivery date.
